(19) United States
(12) Patent Application Publication
(10) Pub. No.: US 2009/0215315 A1
(43) Pub. Date: Aug. 27, 2009

(54) Power connector with improved contacts

(75) Inventor: Yung-Chang Cheng, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/380,526

(22) Filed: Feb. 26, 2009

(30) Foreign Application Priority Data
Feb. 26, 2008 (CN) 200810018565.7

(51) Int. Cl. H01R 13/648

(52) U.S. Cl. 439/607.28

(57) ABSTRACT

An electrical connector includes an insulative housing, a plurality of terminals in the housing and a shield assembled on the housing. The terminals include a conductive grounding contact with separated first grounding contact and second grounding contact. The first grounding contact and second grounding contact respectively includes at least one soldering tail electrically connected to the shield for being electrically connected to each other.

### BACKGROUND OF THE INVENTION

1. Field of the Invention

The present invention relates generally to a Power connector, and more particularly to a Power connector having improved contacts connected cathode.

2. Description of the Prior Art

Direct current (DC) power connects are widely used in electronic devices to transmit electrical power to the devices. US. Pat. No. 6,695,644, issued to Zhao, Qi-jun, discloses a power connect with improved contact. Please refer to FIG. 2 of this patent, the power connector 1 comprises an insulative housing 2, a first conductive contact 5, a second conductive contact 6, a conductive pin 7 and a conductive shield 8. Each of the first conductive contact 5 and the second conductive contact 6 comprises a main body 51 assembly in the rear wall of the housing 2 and a plurality of mating portions 53 integrally formed with the main body 51 adapted for engaging with a contact of a mating connector, the mating portions 53 assembled in the housing 2 and partly exposed in the receiving space, the mating portions 53 of the first conductive contact 5 arrange on an outer circle and the mating portions 53 of the second conductive contact 6 arranged on an inner circle inside the outer circle. However, the second conductive contact 6 is substantially of columnar configuration which have to go through a complicated and costly manufacturing processes. But if the second conductive contact 6 is divided into two parts, an Electro-Static-discharging (ESD) ability of the power connector will be compromised and reduced.

Hence, in this art, a power connector to overcome the above-mentioned disadvantages of the prior art should be provided.

### BRIEF SUMMARY OF THE INVENTION

A primary object, therefore, of the present invention is to provide a power connector having improved contact for easily producing process and good ESD performance.

In order to implement the above object, the electrical connector comprises an insulative housing, a plurality of terminals assembled in the housing and a metal shell assembled on the housing. The terminals comprise a conductive grounding contact with separated first ground contact and second ground contact. The first ground contact and second ground contact respectively comprises at least one solder tail electrically connected to the metal shell for the metal shell electrically interconnecting the first and second ground contacts

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view illustrating a preferred embodiment of a power connector in according with the present invention;

FIG. 2 is a view similar to FIG. 1, from a rear aspect; and

FIG. 3 is a perspective view of a housing of the power connector of the present invention;

FIG. 4 is an exploded perspective view of FIG. 1; and

FIG. 5 is a view similar to FIG. 4, viewed from a rear aspect;

FIG. 6 is a cross sectional view of the power connector taken along line 6-6 of FIG. 1; and

FIG. 7 is a cross sectional view of the power connector taken along line 7-7 of FIG. 1.

### DETAILED DESCRIPTION OF THE INVENTION

Reference will now be made in detail to a preferred embodiment of the present invention.

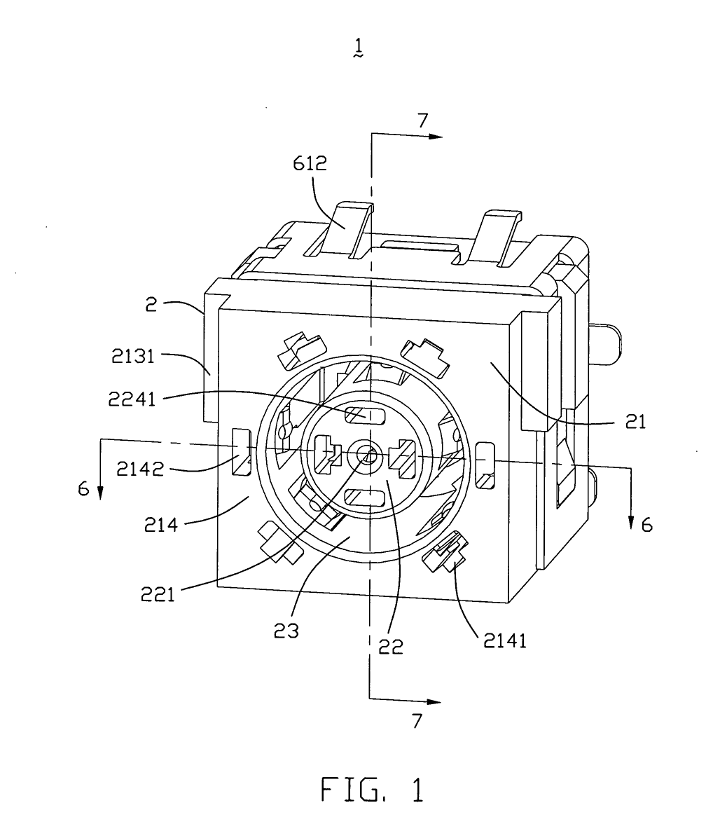

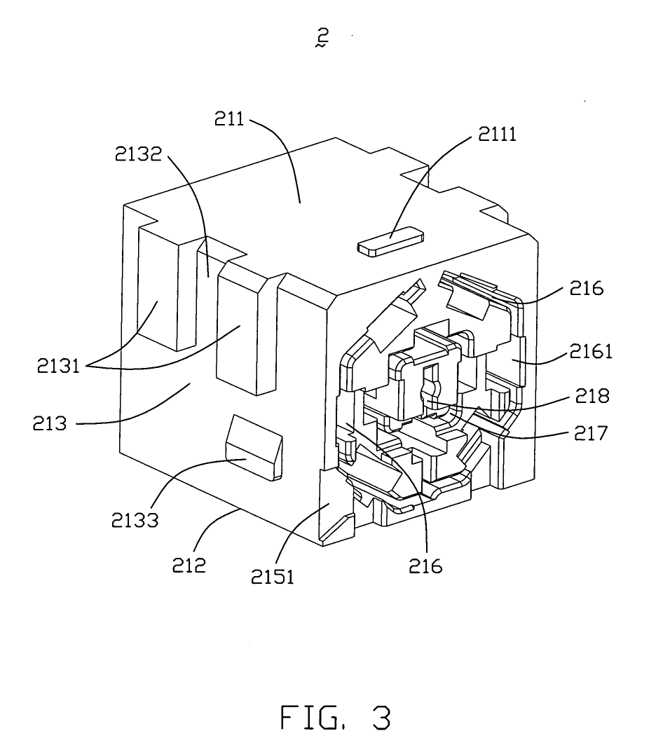

Referencing to FIGS. 1-5, a power connector of the present invention comprises an insulative housing 2, a first conductive contact 3 received in the insulative housing 2, a second conductive contact 4 having two separated portions, a conductive pin 5, and a conductive shield 6 covering the insulative housing 2.

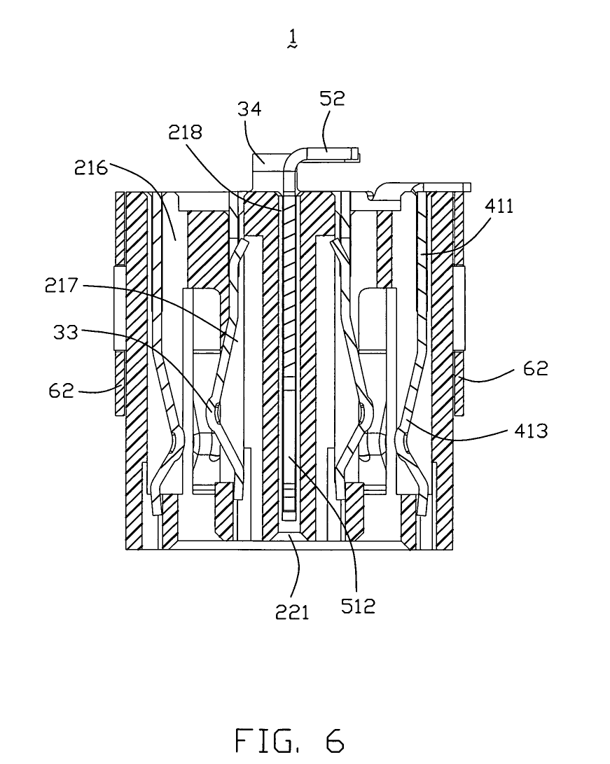

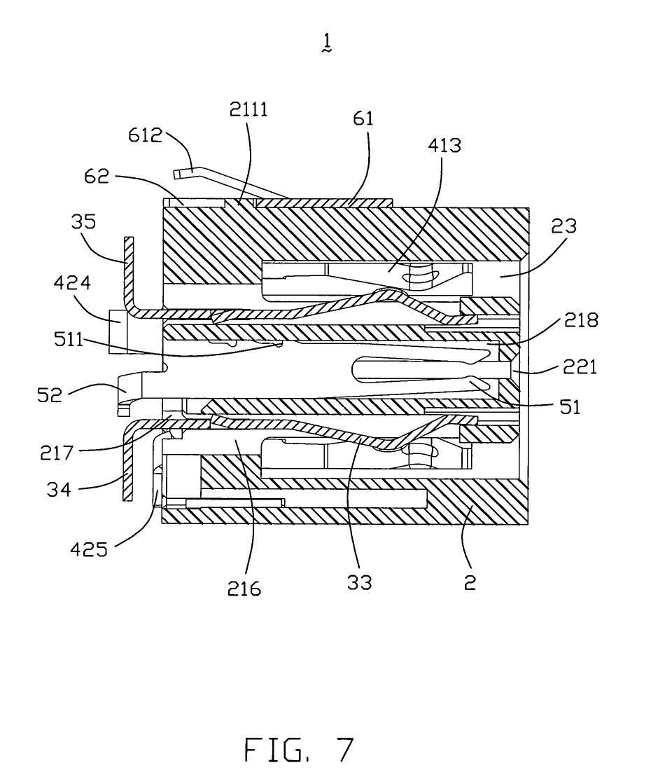

Referencing to FIGS. 1, 4, 6 and 7, the insulative housing 2 is of cubicial configuration. The insulative housing 2 comprises an outer portion 21 which comprises a top wall 211, a bottom wall 212, a pair of side walls 213 connecting the top wall 211 to the bottom wall 212, a front wall 214, and a rear wall 215. An annular receiving space 23 is defined therein and extends rearwards from a front face (not labeled) of the housing 2, creating a cylindrical inner portion 22 of the housing 2 which extends forwardly from a rear wall 215 of the housing 2 and is bounded on its sides by the receiving space 3. A receiving hole 221 is defined along a longitudinal axis of the inner portion 22 and a plurality of receiving slots 2241 is formed to surround the receiving hole 221 on the inner portion 22 of the housing 2. A rib 2111 is defined on a rear portion (not labeled) of the top wall 211. A pair of rectangular first apertures 2142 and four T-shaped second apertures 2141 are formed along a longitudinal axis of the housing from a front wall 214. The two first apertures 2142 are respectively on the two sides of the receiving space 23, and the second apertures 2141 are symmetrically arranged on the circumambience of the receiving space 23 along a transverse axis through the center of the hole 221. A first receiving groove 216 frontward extends from the rear wall 215 of the housing 2 to be connected to the two first apertures 2142 and the four second apertures 2141 for the receiving the second conductive contact 4. The first receiving groove 216 comprises a plurality of guiding grooves 2161, 2162, 2163 respectively extending along different directions to be cooperated with the shape of the second conductive contact 4. A second receiving groove 217 extends frontward from the rear wall 215 of the housing 2 and communicating at its forward ends with the receiving space 23. The second receiving groove 217 is substantially viewed as a rectangular from a rear aspect and encircled by the first receiving grooves 216 for receiving the first conductive contact 3. A third receiving groove 218 is defined on the center of the housing 2 and from the rear wall 215 of the housing 2 to communicate with the receiving hole 221. The third receiving groove 218 is surrounded by the second receiving groove 217 to receive the conductive pin 5. A cutout 2151 is defined on one corner connected one of the side walls 213 of the housing 2. Each of the two side walls 213 comprises a pair of bars 2131 to form a spacing groove 2132 between two bars 2131, and a cuneal block 2133 just below the rear bar 2131.

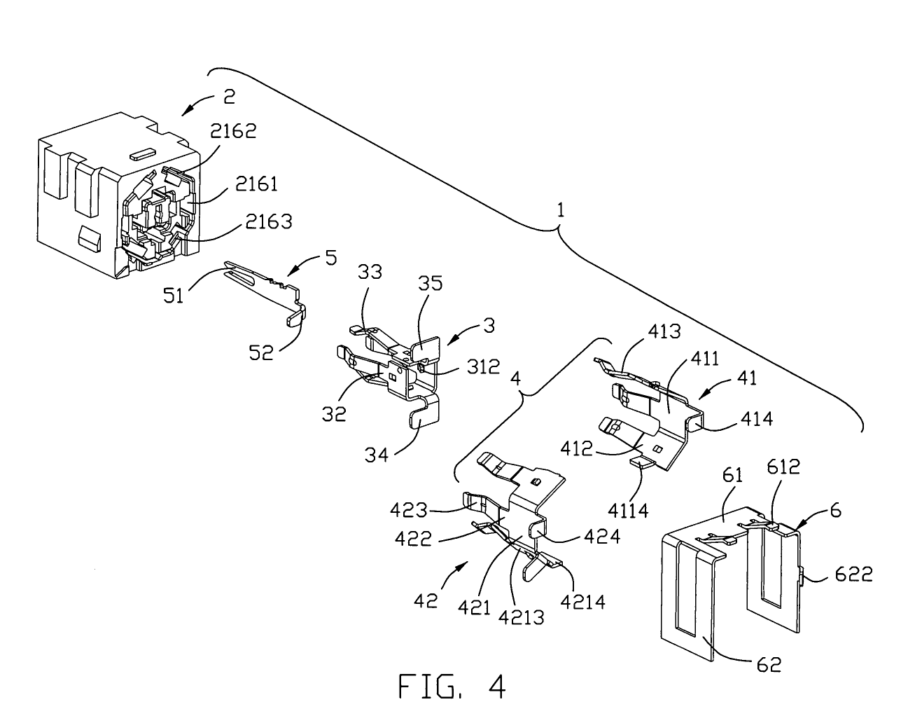

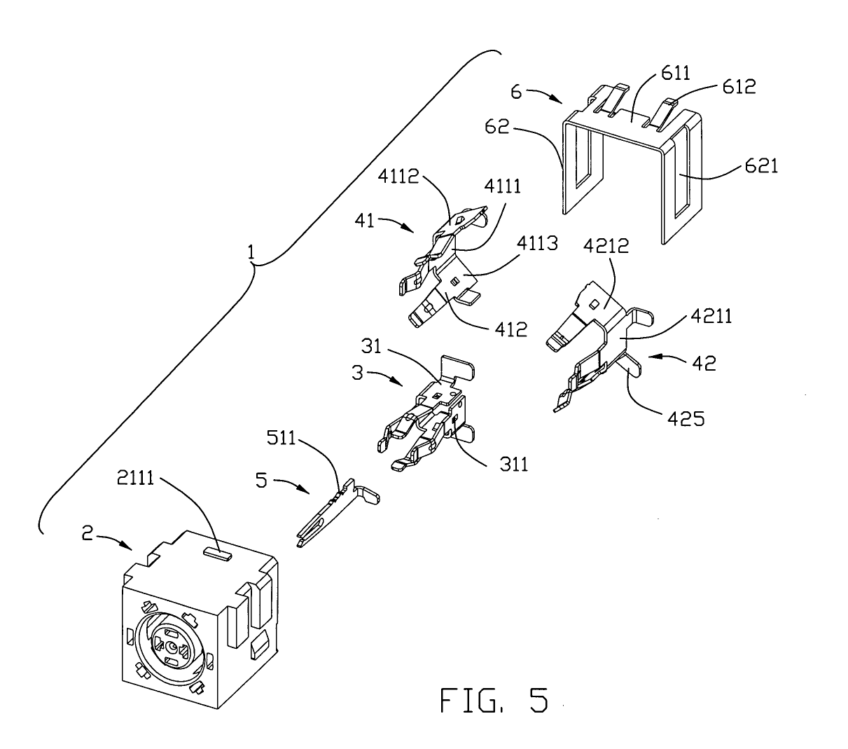

Referencing to FIG. 4 and FIG. 5, the first conductive contact 3 comprises a rectangular main portion 31, and four mating portions 33 respectively frontward extending from four walls (not labeled) of the main portion 31, two soldering portion 34, 35 respectively rearwards extending from the upper wall and the lower wall of the main portion 31 to form an L-shaped surface. The two soldering portions 34, 35 are mirror symmetrically arranged along a transverse axis. Each of the four walls of the main portion 31 comprises a rectangular hole 311 to form a slice 312 inward extending from the hole 311.

Referencing to FIGS. 4 and FIG. 5, the second conductive contact 4 comprises a first grounding contact 41 and a second grounding contact 42 separated from the first grounding contact 41. The first grounding contact 41 comprises a first main section 411 and three first mating sections 413 frontward extending from the first main section 411, and an L-shaped soldering tail 414 rearwards extending from the rear edge of the first main section 411. The first main section 411 comprises a first, second and third metal patches 4111, 4112, 4113 respectively extending along different directions, a key 4114 inward extending from the lower edge of the third metal patch 4113. The second and the third metal patches 4112, 4113 respectively comprise a tab (not labeled) on the center thereof. The three first mating sections 413 are separated from each other and each thereof respectively extends from one of the three metal patches 4111, 4112, 4113. The second grounding contact 42 comprises a second main section 421 also having three metal patches 4211, 4212, 4213, a plurality of second mating sections 423 respectively extending frontward from the three metal patches 4211, 4212, 4213 of the second main section 421 to be separated from each other, an L-shaped second solder section 424 rearwards extending from the rear edge of the second main section 421, and a solder slice 425 rearwards extending from the rear edge of the second main section 421 to form an end along a slant direction. The second main section 421 comprises an attaching tail 4214 downwards extending from the lower edge of the third metal patch 4213. The second and third metal patches 4212, 4213 respectively comprise a tab (not labeled) on the center thereof. In this embodiment, the amount of the second mating sections 423 is three and each of the second mating sections 423 respectively extends from one of the metal patches 4111, 4112, 4113. The first grounding contact 41 and the second grounding contact 42, each of which has three metal patches, can be combined to for a hexagonal configuration.

Referencing to FIGS. 4 and 5, the conductive pin 5 comprises a mating portion 51 having a tuning-fork shape and a soldering portion 52 rearwards extending from the mating portion 51. A plurality of barbs 511 is integrally formed on the back end of the upper edge of the mating portion 71.

Referencing to FIGS. 4 and 5, the shield 6 has the shape of an inverted “n” and comprises a top patch 61 and a pair of side patches 62 downward extending from the top patch 61. A cutout (not labeled) is defined on the back end of the top patch 61. A nose 611 rearward extends from the top wall to be located in the cutout. A pair of flexible arms 612 rearwards and upward extends from the top wall on the two sides of the nose 611 to form an end parallel to the top wall 61 for securely fixing the power connector to an electrical device. Each of the two side patches 62 defines a rectangular opening 621 downward extending from the top wall 61 to make the side patches 62 become a frame with two side arms (not labeled) and a lower arm (not labeled). One of the two side patches 62 has a soldering piece 622 rearwards and inward extending from the rear edge thereof.

The first conductive contact 3 acts as a positive contact serves as anode, transmitting positive signal, while the second conductive contact acts a negative contact serves as cathode, transmitting positive signal for the power connector 1. Now, referencing to FIGS. 1 to 7, in assembly, the first conductive contact 3 is assembled in the housing 2 from rear end thereof. The main portion 31 is received in the second receiving groove 217 of the housing 2 with the tabs 312 engaging the second receiving groove 217 for securely fixing the main portion 31 to the housing 2. Each of the mating portions 33 protrudes from the second groove 217 into its corresponding receiving slot 2241 with an end contacting to an outer wall (not labeled) of the receiving slots 2241 and its top (not labeled) exposed in the receiving space 23 of the housing 2. The soldering portions 34, 35 are exposed on the back of the housing 2 and can be connected with cables transmitting positive electricity.

The second conductive contacts 4 are assembled in the housing 2 from the rear thereof with the first and second main sections 411, 421 being respectively received in the first receiving groove 216. The six different metal patches 4111, 4112, 4113, 4211, 4212, 4213 of the first and second main sections 411, 412 are respectively received in their corresponding guiding grooves 2161, 2162, 2163 of the first receiving groove 216 with the tabs, the key 4114 and the attaching tail 4214 engaging the first receiving groove for securely fixing the main section 411, 421 to the housing 2. Each of the first and second mating sections 413, 423 respectively protrudes from the first receiving groove 216 into its corresponding first or second aperture 2141, 2142 with its top exposed in the receiving space 23. The solder slice 425 is received in the cutout 2151 of the rear wall 215 of the housing 2 for being electrically connected to the shield 6. The soldering tail 414 of the first grounding contact 41 and the soldering section 424 of the second grounding contact 42 are exposed on the back of the housing 2 to be connected with cables transmitting negative electricity.

The conductive pin 5 is assembled in the housing 2 from the rear wall 215 of the housing 2 and received in the third receiving groove 218 with the barbs 511 engaging the housing 2 for securely fixing the conductive pin 5 to the housing 2. The mating portion 51 of the conductive pin protrude from the third receiving groove 218 into the hole 211 with an end received in the hole 221 for being connected to the complementary connector. The soldering portion 52 is exposed on the back of the housing 2 and can be connected to a wire transmitting signals.

The shield 6 is assembled on the housing 2 from top wall 211. Accordingly, the rear one of the two bars 2131 and the block 2133 are received in the opening 621 of the shield 6 for each of the lower arm of the side patches 62 attached to the lower surface of the block 2133 and each of the front arm of the side patches 62 received in its corresponding spacing groove 2132. The nose 611 is attached to the rib 2111 of the housing 2.

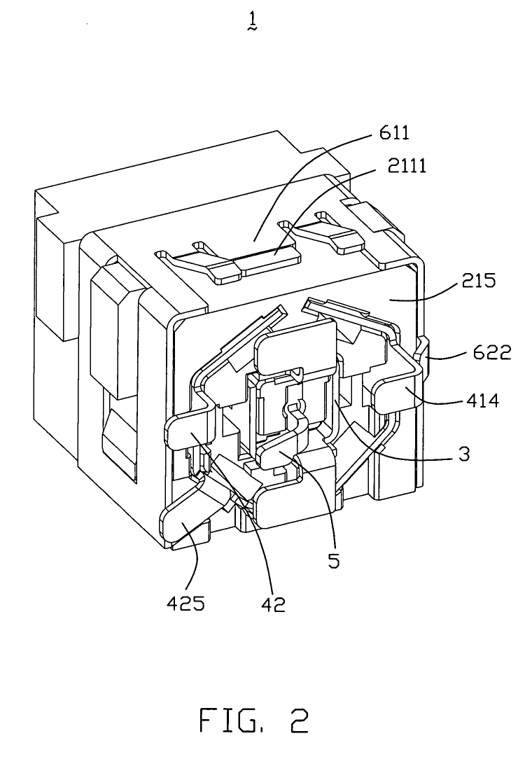

Referencing to FIG. 2, in the power connector, the solder slice 425 is electrically connected to the shield 6, the soldering piece 622 is electrically connected to the soldering tail 414. Thus, the first grounding contact 41 and the second grounding contact 42 of the second contact 4 are electrically connected to each other through the shield 6, and the static electricity can be discharged through the shield 6.

It is noted that the first contact 3 only forms four mating portions (fingers) 33 while the second contact 4 including the first grounding contact 41 and the second grounding contact 42, forms totally six mating sections (fingers) 413, 423. The reason why the number/amount of the mating portions 33 of the first contact 33 should be less than that of the mating sections 413, 423, is that the first contact 3 is located in an inner circle which is smaller than that where the second contact 4 is located. Understandably, in such a small space if the first contact 3 also contains six mating portions 33, such mating portions 33 should be narrowed for avoiding interference between the neighboring mating portions. On the other hand, because in this embodiment the mating portions 33 are required to be pre-loaded in the corresponding apertures 2241, it is impossible for the housing 2 to form many apertures in such a small circular area. Therefore, in this embodiment, the first (inner) contact 3 only provides four mating portions 33 for the above reasons, while providing six mating sections 413, 423 of the second (outer) contact 4 in a relatively large circular area under consideration of providing more contact points with regard to the mating plug. The difference of the amount of the mating portions of the inner contact and that of the mating sections of the outer contact is an addition feature of the invention.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
an insulative housing;
a plurality of terminals received in the housing and comprising a conductive grounding contact configured by first grounding contact and second grounding contact; and
a metallic shield assembled on the housing;
said first grounding contact and second grounding contact respectively comprising at least one soldering tail electrically connected to the shield for being electrically connected to each other.

2. The electrical connector as claimed in claim 1, wherein said at least one soldering tail mechanically engages the shield.

3. The electrical connector as claimed in claim 2, wherein said first grounding contact comprises a first main section with a first metal patch, a second metal patch connected to the first metal patch and a third metal patch separated from the first metal patch but connected to the second metal patch, and a plurality of first mating sections respectively extending from the three metal patches.

4. The electrical connector as claimed in claim 3, wherein said three metal patches respectively extend along different directions.

5. The electrical connector as claimed in claim 4, wherein said first grounding contact comprises a solder portion extending from a rear edge of the first metal patch to form an L shape and a key inward extending from a lower edge of the first main section.

6. The electrical connector as claimed in claim 5, wherein said second grounding contact is substantially a mirrored image of the first grounding contact and comprises a soldering section extending from the rear edge of the main section along a same direction as the soldering tail of the first grounding contact and a solder slice rearwards extending from the rear edge of the main section along a slant direction.

7. The electrical connector as claimed in claim 2, wherein each of said first grounding contact and the second grounding contact is a half of a hexagonal configuration.

8. The electrical connector as claimed in claim 2, wherein said housing comprises an outer portion which comprises a top wall, a bottom wall, a pair of side walls connecting the top wall and the bottom wall, a front wall and a rear wall and an inner portion surrounded by the outer portion.

9. The electrical connector as claimed in claim 8, wherein said housing further comprises a first receiving groove frontward extending from the rear wall, a receiving space rearwards extending from the front wall and a plurality of apertures rearwards extending from the front wall.

10. The electrical connector as claimed in claim 9, wherein said each of the first and second grounding contacts of the grounding contact is assembled in the housing from the rear wall and comprises a main section received in the first receiving groove and a plurality of mating sections protruding from the first receiving groove into the aperture with a top exposed in the receiving space.

11. The electrical connector as claimed in claim 9, wherein said housing further comprises a second receiving groove frontward extending from the rear wall and a plurality of receiving slots respectively rearwards extending from the front surface of the inner portion.

12. The electrical connector as claimed in claim 11, further comprising a first conductive contact having a main portion received in the second receiving groove and a plurality of mating portions respectively extending from the main portion in the second receiving groove into the receiving slots with tops exposed in the receiving space.

13. The electrical connector as claimed in claim 8, wherein said housing further comprises a third receiving groove frontward extending from the rear wall and a receiving hole rearwards extending from the front surface of the inner portion to be connected to the third receiving groove.

14. The electrical connector as claimed in claim 13, further comprising a conductive pin having a mating portion of a tuning-fork shape received in the third receiving groove with its end exposed in the receiving hole, a soldering portion rearward extending from the mating portion and a plurality of barbs defined on the upper edge of the mating portion to engage the first receiving groove for securely fixing the conductive pin to the housing.

15. An electrical connector comprising:
an insulative housing defining an annular receiving space and a receiving hole located in a center of said annular receiving space;
a signal contact disposed in the housing having a contact section received in the receiving hole for mating with a signal terminal of a mating plug;
an inner contact located in the housing and by an inner side of the annular receiving space, said inner contacts defining a plurality of inner mating fingers outwardly extending into the annular receiving space;
an outer contact located in the housing and by an outer side of the annular receiving space, said outer contacts defining a plurality of outer mating fingers inwardly extending into the annular receiving space; wherein
an amount of said inner mating fingers is smaller than that of said outer mating fingers.

16. The electrical connector as claimed in claim 15, wherein the inner contact is of one piece while the outer contact is of two pieces discrete from each other each including a solder tail.

17. The electrical connector as claimed in claim 15, wherein the inner contact is of one piece while the outer contact is of two pieces discrete from each other electrically connected to each other via a metallic shell covering said housing.

18. An electrical connector comprising:
an insulative housing defining an annular receiving space and a receiving hole located in a center of said annular receiving space;
a signal contact disposed in the housing having a contact section received in the receiving hole for mating with a signal terminal of a mating plug;
an inner contact located in the housing and by an inner side of the annular receiving space, said inner contacts defining a plurality of inner mating fingers outwardly extending into the annular receiving space;
an outer contact located in the housing and by an outer side of the annular receiving space, said outer contacts defining a plurality of outer mating fingers inwardly extending into the annular receiving space;
said outer contact including pieces discrete from each other while electrically connected with each other via a metallic shield covering an exterior of the housing.

19. The electrical connector as claimed in claim 18, wherein each of said pieces includes a solder tail which engages the shield.

20. The electrical connector as claimed in claim 19, wherein said inner contact and said signal contact have corresponding solder tails coplanar with the solder tails of the pieces of the outer contact.
